(19) United States
(12) Patent Application Publication
(10) Pub. No.: US 2026/0017254 A1
(43) Pub. Date: Jan. 15, 2026

(54) END-TO-END AUTOMATED LARGE LANGUAGE MODEL EVALUATION AND DEPLOYMENT

(71) Applicant: INTUIT INC., Mountain View, CA (US)

(72) Inventors: Prateek ANAND, Mountain View, CA (US); Yi WEI, Mountain View, CA (US); Hui Kara Bethany LIU, Mountain View, CA (US); Ichen Jennifer BUSHONG, Mountain View, CA (US); Britt SEABERG-LOVE, Mountain View, CA (US); Steven James BROWN, Mountain View, CA (US); Jineet Hiren DOSHI, Mountain View, CA (US); Zhewen FAN, Mountain View, CA (US)

(73) Assignee: INTUIT INC., Mountain View, CA (US)

(21) Appl. No.: 18/767,899

(22) Filed: Jul. 9, 2024

(51) Int. Cl. G06F 16/242; G06F 16/248

(52) U.S. Cl. CPC G06F 16/243; G06F 16/248

(57) ABSTRACT

At least one processor may receive a user query and generate a first prompt including at least the user query. The at least one processor may input the first prompt to a first large language model (LLM) and receive a first response from the first LLM. The at least one processor may generate a second prompt including a context of a processing state of a computing system and/or an expected response, input the second prompt to a second LLM different from the first LLM, and receive a second response from the second LLM. The at least one processor may determine a validity verdict of the first response using the second response. The at least one processor may generate an answer to the user query, wherein the answer includes the first response for a valid verdict or omits the first response for an invalid verdict.

### BACKGROUND

Generative artificial intelligence (GenAI) projects often incorporate comprehensive evaluation of responses generated by large language models (LLMs). This is particularly true when the LLM is being asked to provide responses to questions related to esoteric subject matter on which a general-purpose LLM may not be trained. For example, in the tax domain, LLMs may be trained on some tax information but not necessarily on all details of local tax laws, rules, or best practices. Accordingly, tax experts may be called upon to manually evaluate LLM responses using their domain knowledge.

Every prompt (or fine-tuning) iteration triggers an evaluation cycle. The evaluation cycle proceeds as follows. First, a new use case is conceived. Next, a prompt is built, where the prompt can include a question, context surrounding the question, and instructions on how to respond to the question. The prompt is sent to an LLM to get a response, and the response is evaluated by tax experts. If issues are seen with the response, the prompt is modified to elicit another response which potentially matches the desired response. LLM prompting, evaluation, and modification can be repeated until a desired response is achieved.

If experts are required for evaluation, such as in the tax domain example, every evaluation cycle has a high cost attached to it in terms of experts' bandwidth, number of experts needed for evaluations, or both. If expert participation is replaced with automated iteration through the evaluation cycle on a one-to-one basis, such that prompts are evaluated by an automated process, a new problem is introduced that is particular to the technical setting. Specifically, there is no procedure for the automated process to interpret user-supplied questions that deviate from expected inputs, meaning that the automated process might inaccurately evaluate questions due to minor changes in question wording, spelling, phrasing, etc., and these inaccuracies may themselves be quite unpredictable.

### BRIEF DESCRIPTIONS OF THE DRAWINGS

FIG. 1 shows an example LLM evaluation and deployment system according to some embodiments of the disclosure.

FIG. 2 shows an example LLM evaluation and deployment process with existing evaluation data according to some embodiments of the disclosure.

FIG. 3 shows an example automatic prompt update process according to some embodiments of the disclosure.

FIG. 4 shows an example LLM evaluation and deployment process without existing evaluation data according to some embodiments of the disclosure.

FIG. 5 shows an example context determination process according to some embodiments of the disclosure.

FIG. 6 shows an example computing device according to some embodiments of the disclosure.

### DETAILED DESCRIPTION OF SEVERAL EMBODIMENTS

Systems and methods described herein can automate LLM output evaluations with high accuracy while avoiding technical problems that would otherwise occur with automation. For example, disclosed embodiments can use a second LLM as a judge that evaluates responses from a first LLM. Due to the specialized nature of some domains (e.g., the tax domain), out-of-the-box LLMs may fail to accurately evaluate the tax accuracy of responses from another LLM. Accordingly, embodiments described herein can infuse domain knowledge in the judge LLM prompt to improve evaluation performance and ultimate response accuracy. In at least some embodiments, in order to infuse tax experts' domain knowledge in the judge LLM, the disclosed systems and methods can leverage the observations (e.g. types of inaccuracies) from a first round of tax expert evaluation. In at least some embodiments, the disclosed systems and methods can improve robustness and allow for evaluation of unexpected or unusual questions by determining prompt context and supplying the judge LLM with the context. The embodiments described herein thus not only solve the basic problem of scaling LLM response evaluation, but also solve technical problems that are unique to the automation of LLM response evaluation with no equivalent in manual LLM response evaluation.

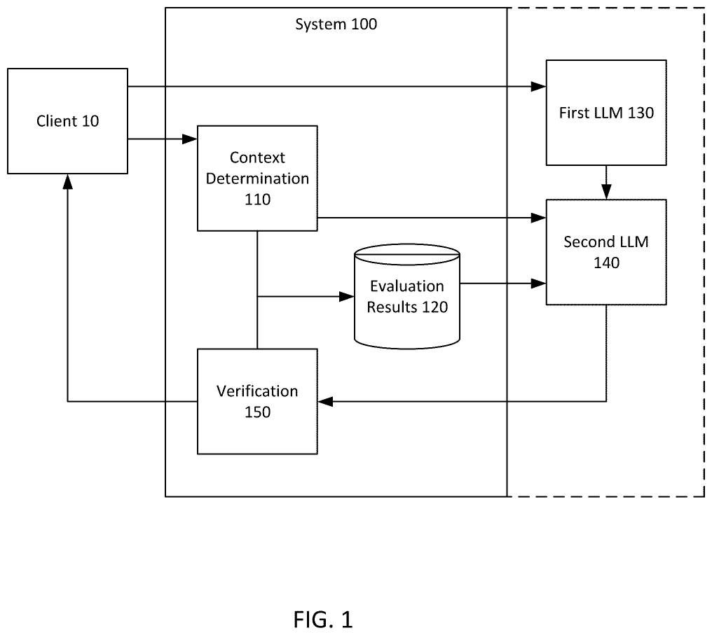

FIG. 1 shows an example LLM evaluation and deployment system 100 according to some embodiments of the disclosure. System 100 may include context determination module 110, evaluation results database 120, and/or verification module 150, the features and functions of which are described in detail below. In some embodiments, system 100 may include first LLM 130 and/or second LLM 140, while in other embodiments, one or both of first LLM 130 and second LLM 140 may be separate from, and in communication with, system 100. In some embodiments, system 100 may include additional modules (not shown) that are commonly included in user-oriented platforms such as tax preparation platforms and/or other modules. As described in detail below, system 100 may interact with client 10 to process user queries entered through a user interface (UI) presented at client 10, for example.

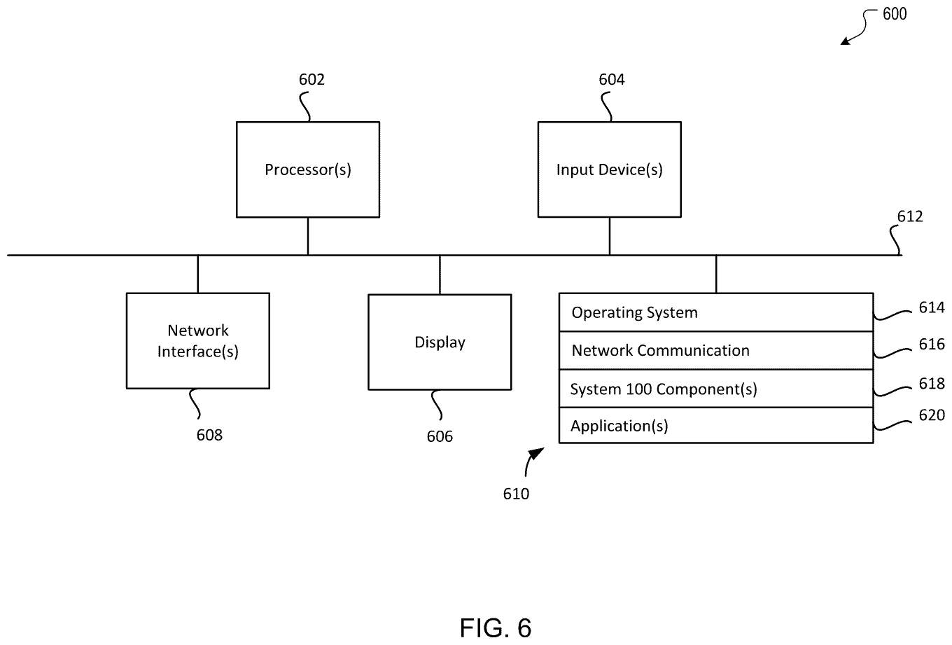

Illustrated components may include a variety of hardware, firmware, and/or software components that interact with one another. Some components shown in FIG. 1 may communicate with one another using networks. For example, client 10 may access system 100 through one or more networks (e.g., the Internet, an intranet, and/or one or more networks that provide a cloud environment). In another example, such as when system 100 is separate from first LLM 130 and/or second LLM 140, system 100 and first LLM 130 and/or second LLM 140 may communicate with one another through the one or more networks. Each component may be implemented by one or more computers (e.g., as described below with respect to FIG. 6).

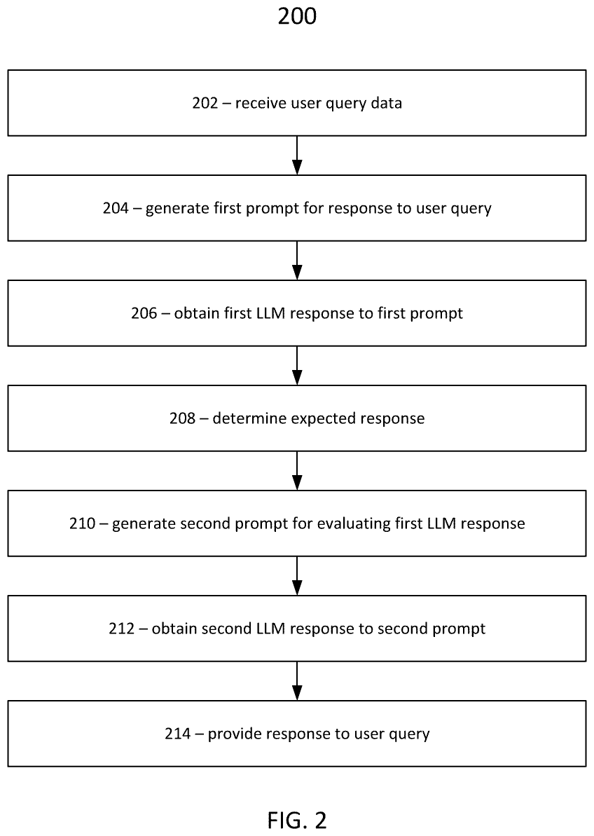

The elements of system 100 are described in greater detail below with respect to FIGS. 2-5. but in general, client 10 can receive user input defining a query, and first LLM 130 can respond to the query. System 100 can evaluate the response to the query from first LLM 130. For example, context determination module 110 can determine a context under which the query was formed and/or evaluation results database 120 can provide evaluation data relevant to the query. Second LLM 140 can process data from context determination module 110 and/or evaluation results database 120, along with the response from first LLM 130, and provide a result. Verification module 150 can process the result from second LLM 140 to determine the validity of the response from first LLM 130. If the response from first LLM 130 is valid, system 100 can provide the response from first LLM 130 to client 10 as a response to the initial user query. Otherwise, system 100 can determine an appropriate response to send to client 10 in cases where the response from first LLM 130 is not valid.

Elements illustrated in FIG. 1 (e.g., system 100 (including context determination module 110, evaluation results database 120, and/or verification module 150), first LLM 130, second LLM 140, and client 10) are each depicted as single blocks for ease of illustration, but those of ordinary skill in the art will appreciate that these may be embodied in different forms for different implementations. For example, while separate modules of system 100 are depicted separately, any combination of these elements may be part of a combined hardware, firmware, and/or software element. Moreover, while the modules are depicted as parts of a single system 100 element, any combination of these elements may be distributed among multiple logical and/or physical locations. Also, while one client 10, one system 100 with one context determination module 110, evaluation results database 120, and verification module 150, one first LLM 130, and one second LLM 140 are illustrated, this is for clarity only, and multiples of any of the above elements may be present. In practice, there may be single instances or multiples of any of the illustrated elements, and/or these elements may be combined or co-located. For example, system 100 may interact with multiple clients 10.

In the following descriptions of how the illustrated components function, several examples are presented, including examples using specific data or data types such as queries related to tax preparation. However, those of ordinary skill in the art will appreciate that these examples are merely for illustration, and the disclosed embodiments are extendable to other application and data contexts.

FIG. 2 shows an example LLM evaluation and deployment process 200 with existing evaluation data according to some embodiments of the disclosure. In this process 200, system 100 can access data indicating expected response(s) to given prompt(s). For example, in some embodiments experts can provide the expected responses, and system 100 may store the expected responses (e.g., in evaluation results database 120 and/or some other data store(s)). Second LLM 140 can use the expected responses to evaluate whether responses by first LLM 130 are likely to be valid responses to user queries. In at least some embodiments, each of first LLM 130 and second LLM 140 may be separate from, and in communication with, system 100. In at least some embodiments, first LLM 130 may utilize a first model algorithm to generate its responses, and second LLM 140 may utilize a second model algorithm to generate its responses. As a specific, non-limiting example, first LLM 130 may be Claude, and second LLM 140 may be GPT-4.

At 202, system 100 may receive user query data. For example, user query data may include a user query entered through a UI available through client 10. Client 10 may send the user query to system 100. In some embodiments, client 10 may send, and/or system 100 may otherwise obtain, additional data such as context data indicating a processing state of a computing system corresponding to a state of the UI at a time the user query was entered, or the like. For the purposes of explanation, without limiting the scope, the following example assumes the user query is a question about tax filing, and the UI is a tax preparation UI. Thus, assume the user query is as follows: “Why am I getting a refund of $9,868?”

Context data may include a brief topic summary (e.g., “YoYRefundExplanation”) and/or information about the user. For example, assume system 100 can receive prior year tax data for the user (here, for years 2021 and 2022), such as the following: 2021: MFJ, 2 dependents, W-2 wages $24,800, Std Deduct $25, 100, $0 tax liability, WH $2,480, EIC $5,980, ACTC $3,300 ($3,300 recvd in advance), refund $11,760 2022: MFJ, W-2 wages $47k, interest income $200, Std Deduct $25,900, $5k traditional IRA contribution, tax liability $1,633, partial dependent care credit $210, retirement savings credit $400, EIC $1,791, CTC $1,023, ACTC $2,977, $5k of dependent care benefits in box 10 of W-2 which reduces dependent care credit, WH $5,100, refund $9,868

At 204, system 100 may generate a first prompt configured to elicit a response to the user query by first LLM 130. The first prompt can include at least the user query obtained at 202. In some embodiments, the first prompt can further include at least one instruction for responding to the user query, the context data obtained at 202, or a combination thereof.

At 206, system 100 may input the prompt to first LLM 130 and receive a first response from first LLM 130. Due to the natural operation of first LLM 130, responses may vary for multiple queries of the same kind and/or may not be entirely predictable. For example, in response to the same user query, and thus the same prompt, first LLM 130 may return either of the two following responses (among other responses, in some embodiments):

### Response A:

Your income for 2022 was $47,200.
Your filing status was married filing jointly.
You were employed and had $47,000 in wages.
You claimed the $25,900 standard deduction.
Your tax liability before credits was $1,633.
You qualified for $6,401 in total credits including the credits listed.
You paid $5,100 in taxes throughout the year.
You did not owe any penalties.
Your federal refund of $9,868 comes from the $5,100 of tax you already paid and the $6,401 in credits you qualify for so far, minus the $1,633 of total tax on your return.

### Response B:

Your income for 2022 was $47,000.
Your filing status was married filing jointly.
You were employed and had $47,000 in wages.
You claimed the $25,900 standard deduction.
Your tax liability before credits was $1,633.
You qualified for $6,401 in total credits including the credits listed.
You paid $5,100 in taxes throughout the year.
You did not owe any penalties.
Your federal refund of $9,868 comes from the $5,100 of tax you already paid and the $6,401 in credits you qualify for so far, minus the $1,633 of total tax on your return.

At 208, system 100 may determine an expected response to the user query. In at least some embodiments, human expert(s) may prepare expected responses. System 100 may store the expected responses, for example in evaluation results database 120 and/or other data store(s). For example, each context topic (e.g., “YoYRefundExplanation”) may have associated therewith at least one expected response and, where a response is likely to include numbers such as in the present tax preparation example, formulas for determining numerical answers. Thus, for the prompt that resulted in response A and response B above, for example, an expected response may be as follows:

Based on your Married Filing Jointly filing status, wage income of $47,000, interest income of $200, IRA contribution deduction of $5,000, and standard deduction of $25,900, your tax liability is $1,633. You qualify for a dependent care credit of $210, retirement savings credit of $400, child tax credit of $4,000, and an earned income credit of $1,791, so your total credits are $6,401. Additionally, you had federal tax withheld from your wages of $5,100, so your refund to be received is $9,868. The majority of your changes in refund this year relate to the your increase in W-2 wage income and withholdings and their impact on your credits. Although you are receiving new credits this year, such as the dependent care credit and retirement savings credit, you have a smaller earned income tax credit this year, which reduces your refund significantly.

System 100 may include one or more criteria or features in the expert-provided expected response information. For example, experts may provide “buckets” or categories or types of inaccuracies that may be possible, any specific evaluation steps and/or checks the experts used, and/or example expected or ideal responses for test cases.

At 210, system 100 may generate a second prompt configured to elicit an evaluation of the first response from second LLM 140. The second prompt may include, for example, the expected response and the first response along with instructions to cause evaluation of the first response in view of the expected response. In at least some embodiments, the second prompt may include additional information such as at least one evaluation step and/or at least one inaccuracy criterion.

For example, system 100 may generate a second prompt that includes the buckets of inaccuracies, the evaluation steps and/or checks used by experts, one or more examples of buckets and/or evaluation steps/checks, the expected response, the actual first response, and a request to evaluate the first response for accuracy and/or responsiveness to the initial query in view of the other information provided. Providing all of the information (e.g., including the expected response) can improve the accuracy of the second LLM 140 response.

At 212, system 100 may input the second prompt to second LLM 140 and receive a second response from second LLM 140. Because the second prompt included a request to evaluate the first response for accuracy and/or responsiveness, the second response from second LLM 140 should include the requested evaluation. For example, the second response can include a statement to the effect that the first response is “accurate” or “inaccurate.” For accurate responses, the statement alone may suffice as a second response in some embodiments. For inaccurate responses, the second response may further include one or more reasons why the response is inaccurate in some embodiments. In the tax preparation example, such reasons may include lack of accuracy, incorrect math, missing deduction, missing credit, incorrect customer income, missing income information, incorrect filing status, irrelevant information, incorrect tax law, incorrect customer information, etc. Accordingly, to continue the specific example above, if response A is included in the second prompt, second LLM 140 may respond with an indication that response A is accurate. If response B is included in the second prompt, second LLM 140 may respond with an indication that response B is inaccurate for the reason of “missing income information.”

At 214, system 100 (e.g., verification module 150) may provide a response to the user query to client 10, based on the evaluation received at 212. This can include determining a validity verdict of the first response using the second response, wherein the validity verdict indicates that the at least one inaccuracy criterion is met by the first response. For example, if the second response indicates that the first response is accurate (e.g., in the case of response A), system 100 can determine that the at least one inaccuracy criterion is met by the first response. If the second response indicates that the first response is inaccurate (e.g., in the case of response B), system 100 can determine that the at least one inaccuracy criterion is not met by the first response. Depending on the validity verdict, system 100 can generate an answer to the user query and send the answer to the UI of client 10. The answer can include the first response for a valid verdict or omit the first response (e.g., include a default response, a response indicating first LLM 130 was unable to answer, a request for a rephrased query, etc.) for an invalid verdict.

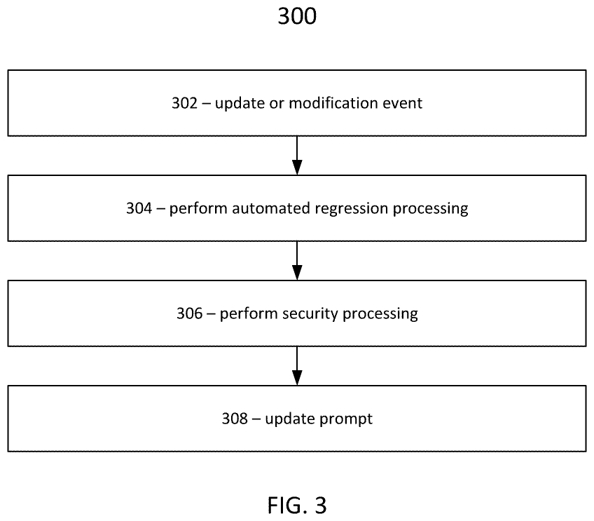

FIG. 3 shows an example automatic prompt update process 300 according to some embodiments of the disclosure. System 100 may perform process 300 to provision evaluation results database 120 in cases where external evaluation of first LLM 130 responses takes place and generates changes to evaluation results.

Before describing the update process 300, it should be understood how external evaluation can be performed in at least some embodiments. For a given topic, the first round of manual evaluations may be performed by subject matter experts (e.g., tax experts) who can assign subject-matter accuracy (e.g., tax accuracy) verdicts (e.g., high/low accuracy) to actual responses by first LLM 130 to actual test prompts. In at least some cases, the experts can also comment on why the LLM response is off if the accuracy verdict is low for a given set of LLM responses/test cases.

In some cases, in the first round of manual evaluations, the experts may provide additional information in order to help automate regression testing for subsequent evaluation cycles (e.g., process 300). For example, experts may identify any additional inaccuracy buckets (if any) beyond those that are already known and stored in evaluation results database 120. Experts may identify any additional specific manual steps (if any) used for examining responses beyond those that are already known and stored in evaluation results database 120. Experts may formulate expected/ideal responses for test cases with low accuracy verdicts. If any sensitive data is identified, it may be stored in s3 buckets or otherwise stored securely. Finally, the expert information may be provided to second LLM 140, and the second LLM 140 responses may be compared with the manual evaluations to verify that they match the experts' evaluations.

At 302, system 100 may determine that the data in evaluation results database 120 should be updated. For example, system 100 may receive updated evaluations from experts that prompts and update. In another example, system 100 may periodically refresh the data in evaluation results database 120.

At 304, system 100 may perform automated regression processing. For example, verification module 150 can run an automated regression tool (e.g., using Pytest as a framework) to validate the accuracy of generated responses from second LLM 140. In at least some embodiments, the automated regression tool may include one or more customizations, such as custom Python scripts for Pytest, that can perform custom regression testing for valid or invalid content within second LLM 140 responses.

At 306, system 100 may perform security processing. For example, verification module 150 can run a security testing suite such as GenSRF to validate that no security vulnerabilities (e.g., susceptibility to prompt injection attacks and/or prompt leakage) are present in the latest versions of the prompts to first LLM 130 and/or second LLM 140.

At 308, system 100 may update the prompt language for the prompts to first LLM 130 and/or second LLM 140 and store them in memory of and/or accessible to system 100. Accordingly, future iterations of process 200 can use the updated prompts in the processing described above.

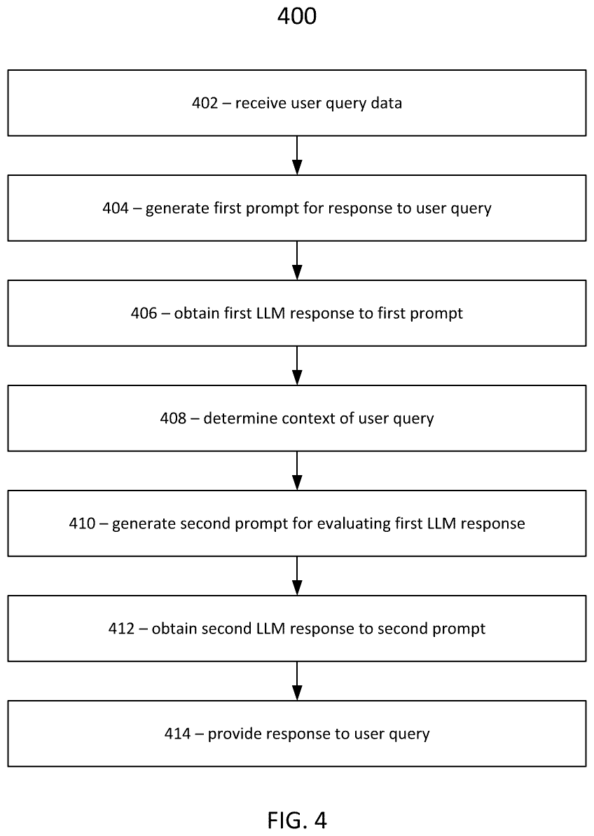

FIG. 4 shows an example LLM evaluation and deployment process 400 without existing evaluation data according to some embodiments of the disclosure. In this process 400, unlike process 200 described above with respect to FIG. 2, system 100 may not access data indicating expected response(s) to given prompt(s) such as expert data. Accordingly, system 100 can use context data obtained by context determination module 110 to evaluate responses by first LLM 130. For example, second LLM 140 can use the context data to evaluate whether responses by first LLM 130 are likely to be valid responses to user queries. In at least some embodiments, each of first LLM 130 and second LLM 140 may be separate from, and in communication with, system 100. In at least some embodiments, first LLM 130 may utilize a first model algorithm to generate its responses, and second LLM 140 may utilize a second model algorithm to generate its responses. As a specific, non-limiting example, first LLM 130 may be Claude, and second LLM 140 may be GPT-4.

At 402, system 100 may receive user query data. For example, user query data may include a user query entered through a UI available through client 10. Client 10 may send the user query to system 100. In some embodiments, client 10 may send, and/or system 100 may otherwise obtain, additional data such as context data indicating a processing state of a computing system corresponding to a state of the UI at a time the user query was entered, or the like. For the purposes of explanation, without limiting the scope, the following example assumes the user query is a question about tax filing, and the UI is a tax preparation UI. Thus, assume the user query is as follows: “Why am I getting a refund of $9,868?”

Context data may include a brief topic summary (e.g., “YoYRefundExplanation”) and/or information about the user. For example, assume system 100 can receive prior year tax data for the user (here, for years 2021 and 2022), such as the following: 2021: MFJ, 2 dependents, W-2 wages $24,800, Std Deduct $25,100, $0 tax liability, WH $2,480, EIC $5,980, ACTC $3,300 ($3,300 recvd in advance), refund $11,760 2022: MFJ, W-2 wages $47k, interest income $200, Std Deduct $25,900, $5k traditional IRA contribution, tax liability $1,633, partial dependent care credit $210, retirement savings credit $400, EIC $1,791, CTC $1,023, ACTC $2,977, $5k of dependent care benefits in box 10 of W-2 which reduces dependent care credit, WH $5,100, refund $9,868

At 404, system 100 may generate a first prompt configured to elicit a response to the user query by first LLM 130. The first prompt can include at least the user query obtained at 402. In some embodiments, the first prompt can further include at least one instruction for responding to the user query, the context data obtained at 402, or a combination thereof.

At 406, system 100 may input the prompt to first LLM 130 and receive a first response from first LLM 130. Due to the natural operation of first LLM 130, responses may vary for multiple queries of the same kind and/or may not be entirely predictable. For example, in response to the same user query, and thus the same prompt, first LLM 130 may return either of the two following responses (among other responses, in some embodiments):

### Response A:

Your income for 2022 was $47,200.
Your filing status was married filing jointly.
You were employed and had $47,000 in wages.
You claimed the $25,900 standard deduction.
Your tax liability before credits was $1,633.
You qualified for $6,401 in total credits including the credits listed.
You paid $5,100 in taxes throughout the year.
You did not owe any penalties.
Your federal refund of $9,868 comes from the $5,100 of tax you already paid and the $6,401 in credits you qualify for so far, minus the $1,633 of total tax on your return.

### Response B:

Your income for 2022 was $47,000.
Your filing status was married filing jointly.
You were employed and had $47,000 in wages.
You claimed the $25,900 standard deduction.
Your tax liability before credits was $1,633.
You qualified for $6,401 in total credits including the credits listed.
You paid $5,100 in taxes throughout the year.
You did not owe any penalties.
Your federal refund of $9,868 comes from the $5, 100 of tax you already paid and the $6,401 in credits you qualify for so far, minus the $1,633 of total tax on your return.

At 408, system 100 may determine a context of the user query for inclusion in a second prompt. As noted above, in at least some embodiments system 100 may determine context at the time of receiving the user query at 402. If not, system 100 may determine context at least prior to generating a second prompt. In either case, context determination module 110 may determine context of a processing state of a computing system corresponding to a state of the UI at a time the user query was entered. The computing system having the context may be client 10, one or more computing systems in communication with client 10 (e.g., server(s) running tax preparation software and providing access thereto), and/or a combination thereof.

To determine the context, context determination module 110 may determine the processing state of the computing system, determine at least one data entry applicable to the processing state, and define the context as data describing at least a portion of the processing state and the at least one data entry. In at least some embodiments, this may include obtaining data from the computing system, which may be separate from, and in communication with, system 100 in at least some cases. In at least some embodiments, context determination module 110 may make a call to an application programming interface (API) of the computing system and receive data indicating the processing state in response. For example, in the tax preparation case, the computing system may include a tax calculation engine (TKE), and the processing state may include at least one of information received by the TKE from the UI, information received by the TKE from at least one additional source, a calculation performed by the TKE, tax data identified by the TKE as being relevant to the user, or a combination thereof.

At 410, system 100 may generate a second prompt configured to elicit an evaluation of the first response from second LLM 140. The second prompt may include, for example, the context and the first response along with instructions to cause evaluation of the first response in view of the expected response. In at least some embodiments, the second prompt may include additional information such as at least one inaccuracy criterion.

For example, system 100 may generate a second prompt that includes the buckets of inaccuracies and/or one or more examples thereof, the context, the actual first response, and a request to evaluate the first response for accuracy and/or responsiveness to the initial query in view of the other information provided. Even in the case where specific expected responses cannot or will not be included, providing context along with inaccuracy bucket data can improve the response from second LLM 140 beyond merely asking for an evaluation.

At 412, system 100 may input the second prompt to second LLM 140 and receive a second response from second LLM 140. Because the second prompt included a request to evaluate the first response for accuracy and/or responsiveness, the second response from second LLM 140 should include the requested evaluation. For example, the second response can include a statement to the effect that the first response is “accurate” or “inaccurate.” For accurate responses, the statement alone may suffice as a second response in some embodiments. For inaccurate responses, the second response may further include one or more reasons why the response is inaccurate in some embodiments. In the tax preparation example, such reasons may include lack of accuracy, incorrect math, missing deduction, missing credit, incorrect customer income, missing income information, incorrect filing status, irrelevant information, incorrect tax law, incorrect customer information, etc. Accordingly, to continue the specific example above, if response A is included in the second prompt, second LLM 140 may respond with an indication that response A is accurate. If response B is included in the second prompt, second LLM 140 may respond with an indication that response B is inaccurate for the reason of “missing income information.”

At 414, system 100 (e.g., verification module 150) may provide a response to the user query to client 10, based on the evaluation received at 412. This can include determining a validity verdict of the first response using the second response, wherein the validity verdict indicates that the at least one inaccuracy criterion is met by the first response. For example, if the second response indicates that the first response is accurate (e.g., in the case of response A), system 100 can determine that the at least one inaccuracy criterion is met by the first response. If the second response indicates that the first response is inaccurate (e.g., in the case of response B), system 100 can determine that the at least one inaccuracy criterion is not met by the first response. Depending on the validity verdict, system 100 can generate an answer to the user query and send the answer to the UI of client 10. The answer can include the first response for a valid verdict or omit the first response (e.g., include a default response, a response indicating first LLM 130 was unable to answer, a request for a rephrased query, etc.) for an invalid verdict.

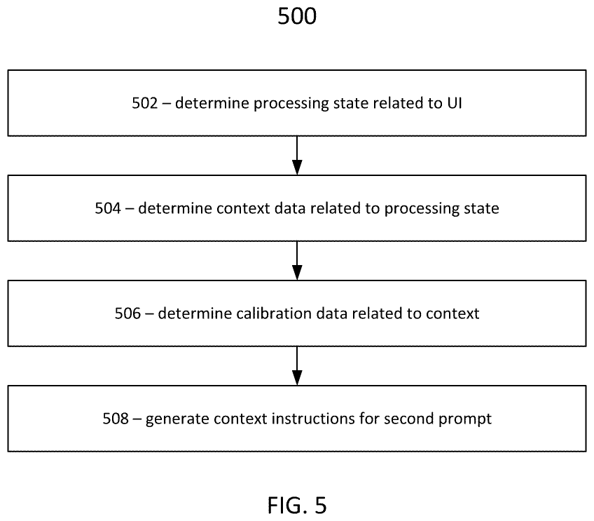

FIG. 5 shows an example context determination process 500 according to some embodiments of the disclosure. System 100 (e.g., context determination module 110) may perform process 500 to prepare context data for inclusion in a second prompt. For example, in process 400, system 100 may perform process 500 at 408 and, subsequently, include the outcome of process 400 in the second prompt generated at 410.

At 502, system 100 may determine a processing state related to the UI at the time at which the user query was received through the UI. For example, one or more computing systems may perform processing causing display of the UI and/or content therein, backend processing affecting the state of the UI and/or content therein, or a combination thereof. Such computing systems may be accessible by one or more APIs. Context determination module 110 may make an API call requesting information describing the processing state, and in turn, the one or more computing systems may provide such information. In some embodiments, client 10 may make the API call, receive the information, and send the information to context determination module 110.

In the tax preparation example, the API call may go to a TKE. The TKE computing system may include a knowledge graph that contains information about a user's tax situation and applicable tax laws and an explainable tax calculation engine that performs calculations using the information. The TKE can populate the knowledge graph as the user enters information through the UI. The explainable part of the tax calculation engine can provide an explainable output file or document (e.g., an xml text) that may include answers to frequently encountered tax questions such as “why is my refund $x?,” “why didn't I qualify for tax credit y?”, etc. The response to the API call can include the user information, applicable tax law information, and or explainable output file or document.

At 504, system 100 may determine context data related to the processing state from 502. For example, context determination module 110 can identify any context data related to the information received at 502 that may or may not be included in the information received at 502. Context data identified at 504 can include, for example, one or more documents or other data related to the information received at 502. In the tax preparation example, this could include IRS rules or guidelines on the tax situation and applicable tax laws reported by the TKE.

At 506, system 100 may determine calibration data related to the context. For example, in at least some embodiments, calibration data may be available for the information received at 502. The calibration data may be validation or spot check information generated by experts that pertains to the state of the computing system. In the tax preparation example, this could include validation notes or corrections on past first responses given in the same or similar tax situation and applicable tax laws reported by the TKE. In some embodiments, the tax situation and applicable tax laws reported by the TKE may be provided to an expert user, who may submit calibration data after reviewing the provided information.

At 508, system 100 may generate context instructions for the second prompt. The context instructions may include the processing state information from 502, the context data from 504, and/or the calibration data from 506. As described above with respect to process 400, the context instructions generated through process 500 may be included as context within the prompt to second LLM 140 (e.g., at 410 of process 400).

FIG. 6 shows a computing device 600 according to some embodiments of the disclosure. For example, computing device 600 may function as system 100 and/or any portion(s) thereof, or multiple computing devices 600 may function as system 100 and/or any portion(s) thereof.

Computing device 600 may be implemented on any electronic device that runs software applications derived from compiled instructions, including without limitation personal computers, servers, smart phones, media players, electronic tablets, game consoles, email devices, etc. In some implementations, computing device 600 may include one or more processors 602, one or more input devices 604, one or more display devices 606, one or more network interfaces 608, and one or more computer-readable mediums 610. Each of these components may be coupled by bus 612, and in some embodiments, these components may be distributed among multiple physical locations and coupled by a network.

Display device 606 may be any known display technology, including but not limited to display devices using Liquid Crystal Display (LCD) or Light Emitting Diode (LED) technology. Processor(s) 602 may use any known processor technology, including but not limited to graphics processors and multi-core processors. Input device 604 may be any known input device technology, including but not limited to a keyboard (including a virtual keyboard), mouse, track ball, and touch-sensitive pad or display. Bus 612 may be any known internal or external bus technology, including but not limited to ISA, EISA, PCI, PCI Express, NuBus, USB, Serial ATA or FireWire. In some embodiments, some or all devices shown as coupled by bus 612 may not be coupled to one another by a physical bus, but by a network connection, for example. Computer-readable medium 610 may be any medium that participates in providing instructions to processor(s) 602 for execution, including without limitation, non-volatile storage media (e.g., optical disks, magnetic disks, flash drives, etc.), or volatile media (e.g., SDRAM, ROM, etc.).

Computer-readable medium 610 may include various instructions 614 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 604; sending output to display device 606; keeping track of files and directories on computer-readable medium 610; controlling peripheral devices (e.g., disk drives, printers, etc.) which can be controlled directly or through an I/O controller; and managing traffic on bus 612. Network communications instructions 616 may establish and maintain network connections (e.g., software for implementing communication protocols, such as TCP/IP, HTTP, Ethernet, telephony, etc.).

System 100 components 618 may include instructions for performing the processing described herein. For example, system 100 components 618 may provide instructions for performing any and/or all of processes 200-500, and/or other processing as described above. Application(s) 620 may be an application that uses or implements the outcome of processes described herein and/or other processes. In some embodiments, the various processes may also be implemented in operating system 614.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In some cases, instructions, as a whole or in part, may be in the form of prompts given to a large language model or other machine learning and/or artificial intelligence system. As those of ordinary skill in the art will appreciate, instructions in the form of prompts configure the system being prompted to perform a certain task programmatically. Even if the program is non-deterministic in nature, it is still a program being executed by a machine. As such, “prompt engineering” to configure prompts to achieve a desired computing result is considered herein as a form of implementing the described features by a computer program.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a backend component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

What is claimed is:

1. A method comprising:
receiving, by at least one processor, a user query entered through a user interface (UI);
generating, by the at least one processor, a first prompt including at least the user query;
inputting, by the at least one processor, the first prompt to a first large language model (LLM) and receiving a first response from the first LLM;
determining, by the at least one processor, a context of a processing state of a computing system corresponding to a state of the UI at a time the user query was entered;
generating, by the at least one processor, a second prompt including at least the context and the first response;
inputting, by the at least one processor, the second prompt to a second LLM different from the first LLM and receiving a second response from the second LLM;
determining, by the at least one processor, a validity verdict of the first response using the second response; and
generating, by the at least one processor, an answer to the user query and sending the answer to the UI, wherein the answer includes the first response for a valid verdict or omits the first response for an invalid verdict.

2. The method of claim 1, wherein the first prompt further includes at least one instruction for responding to the user query, the context, or a combination thereof.

3. The method of claim 1, wherein the second prompt further includes at least one evaluation step, at least one inaccuracy criterion, or a combination thereof.

4. The method of claim 1, wherein determining the context comprises:
determining the processing state of the computing system;
determining at least one data entry applicable to the processing state; and
defining the context as data describing at least a portion of the processing state and the at least one data entry.

5. The method of claim 1, further comprising:
determining, by the at least one processor, the processing state of the computing system by obtaining data from the computing system;
wherein the computing system is separate from, and in communication with, at least one device comprising the at least one processor.

6. The method of claim 1, wherein:
each of the first LLM and the second LLM are separate from, and in communication with, at least one device comprising the at least one processor;
the first LLM utilizes a first model algorithm to generate the first response; and
the second LLM utilizes a second model algorithm to generate the second response.

7. The method of claim 1, wherein the validity verdict indicates at least one inaccuracy criterion met by the first response.

8. The method of claim 1, wherein the computing system comprises a tax calculation engine (TKE), and the processing state includes at least one of information received by the TKE from the UI, information received by the TKE from at least one additional source, a calculation performed by the TKE, tax data identified by the TKE as being relevant to the user, or a combination thereof.

9. A system comprising:
at least one processor; and
at least one non-transitory computer readable medium storing instructions that, when executed by the at least one processor, cause the at least one processor to perform processing comprising:
receiving a user query entered through a user interface (UI);
generating a first prompt including at least the user query;
inputting the first prompt to a first large language model (LLM) and receiving a first response from the first LLM;
determining a context of a processing state of a computing system corresponding to a state of the UI at a time the user query was entered;
generating a second prompt including at least the context and the first response;
inputting the second prompt to a second LLM different from the first LLM and receiving a second response from the second LLM;
determining a validity verdict of the first response using the second response; and
generating an answer to the user query and sending the answer to the UI, wherein the answer includes the first response for a valid verdict or omits the first response for an invalid verdict.

10. The system of claim 9, wherein the first prompt further includes at least one instruction for responding to the user query, the context, or a combination thereof.

11. The system of claim 9, wherein the second prompt further includes at least one evaluation step, at least one inaccuracy criterion, or a combination thereof.

12. The system of claim 9, wherein determining the context comprises:
determining the processing state of the computing system;
determining at least one data entry applicable to the processing state; and
defining the context as data describing at least a portion of the processing state and the at least one data entry.

13. The system of claim 9, wherein:
the processing further comprises determining the processing state of the computing system by obtaining data from the computing system; and
the computing system is separate from, and in communication with, the system.

14. The system of claim 9 wherein:
each of the first LLM and the second LLM are separate from, and in communication with, the system;
the first LLM utilizes a first model algorithm to generate the first response; and
the second LLM utilizes a second model algorithm to generate the second response.

15. The system of claim 9, wherein the validity verdict indicates at least one inaccuracy criterion met by the first response.

16. The system of claim 9, wherein the computing system comprises a tax calculation engine (TKE), and the processing state includes at least one of information received by the TKE from the UI, information received by the TKE from at least one additional source, a calculation performed by the TKE, tax data identified by the TKE as being relevant to the user, or a combination thereof.

17. A method comprising:
receiving, by at least one processor, a user query entered through a user interface (UI);
generating, by the at least one processor, a first prompt including at least the user query;
inputting, by the at least one processor, the first prompt to a first large language model (LLM) and receiving a first response from the first LLM;
determining, by the at least one processor, an expected response to the user query;
generating, by the at least one processor, a second prompt including at least the expected response, at least one evaluation step, at least one inaccuracy criterion, and the first response;
inputting, by the at least one processor, the second prompt to a second LLM different from the first LLM and receiving a second response from the second LLM;
determining, by the at least one processor, a validity verdict of the first response using the second response; and
generating, by the at least one processor, an answer to the user query and sending the answer to the UI, wherein the answer includes the first response for a valid verdict or omits the first response for an invalid verdict.

18. The method of claim 17, wherein the first prompt further includes at least one instruction for responding to the user query, the context, or a combination thereof.

19. The method of claim 17, wherein:
each of the first LLM and the second LLM are separate from, and in communication with, at least one device comprising the at least one processor;
the first LLM utilizes a first model algorithm to generate the first response; and
the second LLM utilizes a second model algorithm to generate the second response.

20. The method of claim 17, wherein the validity verdict indicates that the at least one inaccuracy criterion is met by the first response.
